(19) United States
(12) Patent Application Publication
(10) Pub. No.: US 2017/0257833 A1
(43) Pub. Date: Sep. 7, 2017

(54) SIGNAL DETECTION FROM DIGITAL INTERFACE

(71) Applicant: CommScope Technologies LLC, Hickory, NC (US)

(72) Inventors: Ariful Hannan, Sterling, VA (US); Khalid W. Al-Mufti, Sterling, VA (US); Suryanarayana Ananth Kalenahalli, Chantilly, VA (US)

(21) Appl. No.: 15/335,235

(22) Filed: Oct. 26, 2016

Related U.S. Application Data
(60) Provisional application No. 62/302,538, filed on Mar. 2, 2016.

(51) Int. Cl. H04W 52/28; H04L 12/801

(52) U.S. Cl. CPC H04W 52/28; H04L 47/29; H04W 88/085

(57) ABSTRACT

A digital receiver is provided. The digital receiver includes an oscillator that generates an oscillating signal at a selected frequency, and a complex mixer, coupled to the oscillator and configured to receive samples of a wideband signal from a digital interface. The complex mixer moves a signal of interest in the wideband signal to baseband. The digital receiver also includes at least one filter, coupled to the complex mixer, that down-samples the baseband signal to a narrowband signal and an output, coupled to the at least one filter, that is adapted to output the narrowband signal for analysis.

### BACKGROUND

The traditional monolithic RF base transceiver station (BTS) architecture is increasingly being replaced by a distributed BTS architecture in which the functions of the BTS are separated into two physically separate units—a baseband unit (BBU) and a remote radio head (RRH). The BBU performs baseband processing for the particular air interface that is being used to wirelessly communicate over the RF channel. The RRH performs radio frequency processing to convert baseband data output from the BBU to radio frequency signals for radiating from one or more antennas coupled to the RRH and to produce baseband data for the BBU from radio frequency signals that are received at the RRH via one or more antennas.

The RRH is typically installed near the BTS antennas, often at the top of a tower, and the BBU is typically installed in a more accessible location, often at the bottom of the tower. The BBU and the RRH are typically connected through one or more fiber optic links. The interface between the BBU and the RRH is defined by front-haul communication link standards such as the Common Public Radio Interface (CPRI) family of specifications, the Open Base Station Architecture Initiative (OBSAI) family of specifications, and the Open Radio Interface (ORI) family of specifications.

Wireless operators are under constant pressure to increase the speed, capacity and quality of their networks while continuing to hold the line on cost. As technologies evolve, the challenge is becoming increasingly difficult. One specific reason: the escalating occurrence and cost of passive intermodulation (PIM).

Already recognized as a significant drain on network performance and profitability, the problem of PIM is intensifying. Advanced wireless equipment is becoming more sensitive, and new technologies like LTE are increasingly noise limited. It has been noted that a 1 Decibel drop in uplink sensitivity due to PIM can reduce coverage by as much as 11 percent.

Testing for PIM using conventional coaxial RF testing equipment is slow, costly and dangerous. Each sector, frequency and technology must be individually connected and tested. So, most operators resort to PIM testing only after detecting a significant rise in the noise floor or a drop in connection quality. Therefore, improvements in PIM testing are needed so that operators can afford to make PIM testing a regular part of their network acceptance and preventative maintenance programs thereby increasing the profitability of their network in an increasingly competitive marketplace.

Detecting signals, such as PIM products, from a digital interface which carries a wideband, digitized RF/IF signal is difficult. Conventional spectral analysis of such signals is computationally intensive. Further, noise levels in the signal also complicate the process. PIM products, or other signals of interest, may have power levels as low as −150 dBm and thus are difficult to detect using conventional spectrum analyzers.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of one exemplary embodiment of a passive intermodulation (PIM) tester for a distributed base station system within which the techniques for detecting a signal described herein can be used.

FIG. 2 is a block diagram of one exemplary embodiment of a digital receiver.

FIG. 3 is a flow diagram of one exemplary embodiment of a method analyzing a wideband signal.

FIG. 4 is a flow diagram of one exemplary embodiment of a method of testing for PIM products in a distributed base station.

FIG. 5 is a spectrum diagram that illustrates an example of calculations that can be used to identify the location of potential PIM products in a distributed base station having two downlink channels according to one embodiment of the present invention.

FIG. 6 is a flow diagram of another exemplary embodiment of a method for identifying pairs of tones to be used for PIM testing in a distributed base station.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

The embodiments described below enable analyzing a wideband signal from a digital interface, e.g., a wideband signal with a potential signal of interest in a narrow portion of the wideband signal. In particular, embodiments of the present invention receive baseband data from a front-haul communication link that might contain a signal of interest, e.g., a PIM product, interference or other signal. Exemplary embodiments move the potential signal of interest to baseband and filter and down-sample the signal. In some embodiments, a dynamic scaling technique is used to prevent distortions in the output signal due to the wide range of potential input signals that could be processed. With this dynamic scaling technique, the scaling levels are adjusted depending on the power level of the received signal and the technique produces accurate power measurement of the filtered signal.

### Distributed Base Station System

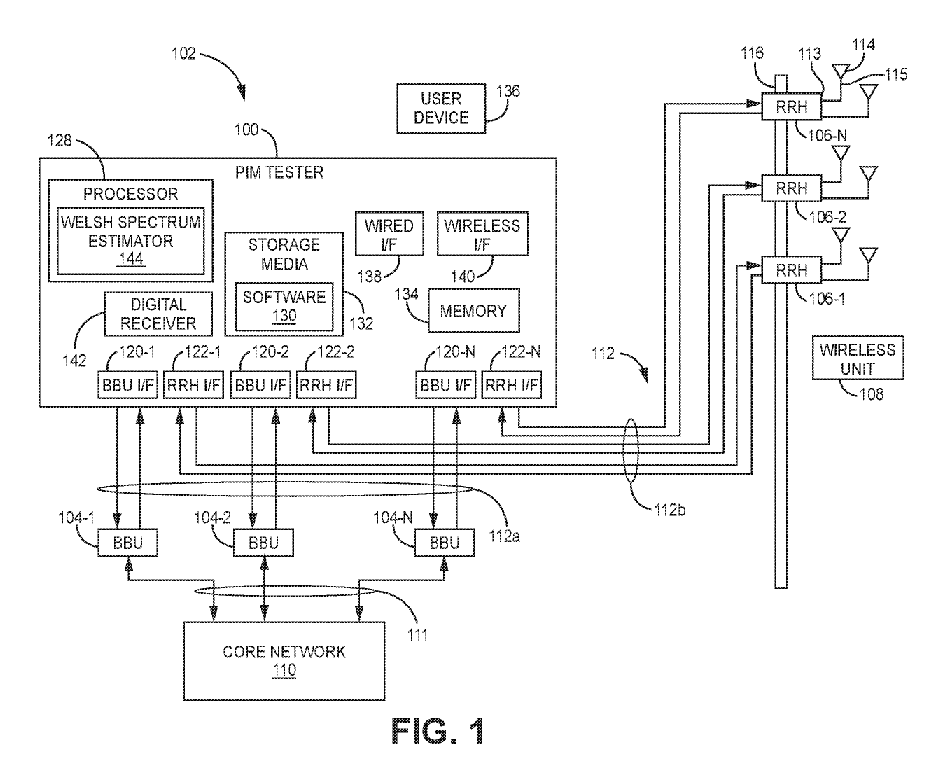

FIG. 1 is a block diagram of one exemplary embodiment of a passive intermodulation (PIM) tester 100 for a distributed base station system, indicated generally at 102, with in which the techniques for testing for PIM products described here can be used. While the embodiments are described herein with respect to an optical PIM tester, it should be understood that the systems and methods described herein apply to analyzing signals for any digital interface outputting an RF/IF signal.

In the exemplary embodiment shown in FIG. 1, the system 102 comprises a plurality of baseband units (BBU) 104-1 to 104-N and a plurality of remote radio heads (RRH) 106-1 to 106-N that communicate over a plurality of wireless radio frequency (RF) channels with one or more wireless units 108 (such as mobile telephones, smartphones, tablets, wireless modems for laptops or other computers or for other devices such as wireless sensors or other “Internet of Things” (JOT) or machine-to-machine (M2M) devices) using one or more standard wireless air interfaces. The exemplary embodiment of system 102 shown in FIG. 1 may support several air interfaces, e.g., three air interfaces including, but not limited to, Long-Term Evolution (LTE) 4G air interface described in the “Third Generation Partnership Project (3GPP) Technical Specification (TS) 36.211 Evolved Universal Terrestrial Radio Access (E-UTRA); Physical Channels and Modulation” specification produced by the 3GPP, Advanced Wireless Services (AWS-1), Personal Communications Services (PCS), CLR, GSM, WiMax, and others. It is to be understood that other air interfaces can be used.

Each BBU 104 is communicatively coupled to the core network 110 of a wireless service provider using a suitable bi-directional backhaul communication link 111 and interface (for example, using a wireless or wired ETHERNET connection and using the LTE 51 interface). The backhaul communication link 111 can also be used for base station-to-base station communications using the LTE X2 interface.

Each BBU 104 is communicatively coupled to a corresponding RRH 106 using a bi-directional front-haul communication link 112. In the exemplary embodiment shown in FIG. 1, the bi-directional front-haul communication link 112 is implemented using a plurality of pairs of optical fibers, where, in each pair, one optical fiber is used for downlink communications from the BBU 104 to the RRH 106 and the other optical fiber is used for uplink communications from the RRH 106 to the BBU 104. Further, as shown in FIG. 1, the plurality of optical fibers 112 are split into two parts; a first part 112a connecting BBU 104 to optical PIM tester 100 and a second part 112b connecting optical PIM tester 100 to a respective RRH 106. It is to be understood that the front-haul communication link 112 can be implemented in other ways. The exemplary embodiment shown in FIG. 1 is described here as using a CPRI interface for communications between each BBU 104 and the corresponding RRH 106 over the front-haul communication link 112. It is to be understood, however, that a different front-haul interface could be used (for example, the OB SAI or ORI interface).

As noted above, each BBU 104 performs baseband processing for the particular air interface that is being used to wirelessly communicate over its assigned RF channel, and the RRH 106 performs radio frequency processing to convert baseband data output from the BBU 104 to radio frequency signals for radiating from one or more antennas 114 that are connected to the RRH 106 at antenna port 113 via coaxial cable 115 and to produce baseband data for the associated BBU 104 from radio frequency signals that are received at the RRH 106 via one or more antennas 114.

During normal operation of the system 102, in the downlink direction, the BBUs 104 generate downlink baseband IQ data to encode frames of downlink user and control information received from the core network for communication to the wireless units 108 over the appropriate wireless RF channels. The downlink baseband IQ data is communicated from the BBUs 104 to the RRHs 106 over the respective front-haul communication link 112. The RRHs 106 receive the downlink baseband IQ data and generate one or more downlink analog radio frequency signals that are radiated from the one or more antennas 114 for reception by the wireless units 108. The wireless units 108 perform baseband processing, in accordance with the air interface, on the received downlink analog RF downlink signals in order to recover the frames of downlink user and control information.

During normal operation of the system 102, in the uplink direction, the wireless units 108 generate, in accordance with the air interface, uplink analog radio frequency signals that encode uplink user and control information that is to be communicated to the core network 110 and transmits the generated uplink analog RF signals over the wireless RF channel. The uplink analog RF signals are received by one or more antennas 114 connected to the RRHs 106. The RRH 106 that receives the uplink analog RF signal produces uplink baseband IQ data from the received uplink analog RF signals. The uplink baseband IQ data is communicated from the RRH 106 to the associated BBU 104 over the front-haul communication link 112. The BBU 104 receives the uplink baseband IQ data and performs baseband processing, in accordance with the air interface, on the uplink baseband IQ data in order to recover the uplink user and control information transmitted from the wireless units 108. The BBU 104 communicates the recovered uplink user and control information to the core network 110 over the backhaul communication link 111 using the backhaul interface.

The RRHs 106 are typically installed remotely from its corresponding BBU 104, near the antennas 114 and is mounted to a structure 116 (such as a tower, pole, building, tree, or other structure). For example, the RRH 104 can be mounted near the top of the structure 116 and the BBU 104 can be located on the ground, where the optical fibers used to implement the front-haul communication link 112 run up the structure 116 to couple the BBU 104 to the RRH 106. Although FIG. 1 shows the RRH 106 mounted near the top of structure 116, the RRH 106 can be mounted at other positions relative to the structure 116, for example, approximately midway between the bottom and top of the structure 116.

### PIM Tester

PIM tester 100 can be coupled to the front-haul communication link 112 in order to capture downlink and uplink frames of data communicated between the plurality of BBUs 104 and the respective plurality of RRHs 106 while the plurality of BBUs 104 and the plurality of RRHs 106 are operating normally. Also, the PIM tester 100 can inject a test signal, e.g., baseband IQ data (e.g. carrier wave (CW) tones or a modulated signal), into the frames of data communicated over the front-haul communication link 112.

In the exemplary embodiments, the PIM tester 100 calculates and injects tones into the downlink baseband IQ data on front-haul communication link 112 to detect PIM products in any uplink channels of system 102. It is to be understood, however, that the PIM tester 100 can be implemented in test equipment that provides other functionality as well. For example, the PIM tester 100 can be implemented in test equipment that includes other functions such as an optical spectrum analyzer, interference detector, and/or signal quality management system. Moreover, one or more of these functions (for example, PIM testing, spectrum analyzer, interference detecting, and signal quality management) can be combined into a single unit. For example, the optical PIM tester 100 described below can also include one or more of spectrum analyzer, interference detection, and/or signal quality management functions, in addition to PIM testing functions.

In exemplary embodiments, the PIM tester 100 and methods described herein may be used to detect the power of a Passive Intermodulation (PIM) signal during PIM testing. PIM occurs when two or more high power RF signals encounter PIM sources or materials in an RF path. These PIM sources behave like a mixer causing new signals to be generated at mathematical combinations of the original RF inputs. When these PIM signals fall in the receive frequency band of the system 102, the resulting interference causes increased dropped calls, reduced data transmission rates, and/or decreased system capacity.

PIM testing involves outputting two or more high power test RF signals on each antenna port 113 associated with a selected RF channel. If the test signals encounter a non-linear junction (for example, at the antenna port 113, in the coaxial cable 115, at the connectors connecting the coaxial cable 115 to the antenna 114 or the antenna port 113, or in the antenna 114) or other PIM source, mixing occurs causing the PIM frequencies (also referred to as PIM products) to be generated. The PIM products travel in all directions from the point of generation. This means they travel in both the downlink and uplink direction. The PIM signals travelling in the uplink direction can be received and analyzed by the optical PIM tester 100.

However, connecting PIM test equipment directly to the antenna ports 113 of the RRH 106 is typically inconvenient, especially when the RRH 106 is mounted near the top of a tower or other structure 116. To avoid having to do this, the optical PIM tester 100 is conveniently coupled to the front-haul communication link 112 near the BBUs 104. This is typically at the base of structure 116 and is thus easily accessible to a technician for running the PIM tests.

In the exemplary embodiment shown in FIG. 1, the optical PIM tester 100 is coupled to the front-haul communication link 112 by connecting the optical PIM tester 100 in-line with the plurality of BBUs 104 and the plurality of RRHs 106. The optical PIM tester 100, in this exemplary embodiment, includes two bi-directional optical interfaces 120, 122 for each RF band supported by the system 102. For each BBU 104, a BBU optical interface 120 provides a connection between optical PIM tester 100 and the associated BBU 104. Additionally, a RRH optical interface 122 provides a connection between the optical signal power tester and the associated RRH 106. Each optical interface 120 and 122 comprises a pair of optical connectors (for example, a pair of LC optical connectors) and an optical transceiver for sending optical signals over one of the optical fibers 112 and for receiving optical signals from another of the optical fibers 112. In one implementation, each optical interface 120 and 122 is implemented using a small form-factor pluggable (SFP) modular optical transceiver that includes integrated optical LC connectors.

Each of the optical interfaces 120 and 122 also includes a respective physical layer device (PHY). In the exemplary embodiment shown in FIG. 1, where a CPRI interface is established over the front-haul communication link 112, the physical layer devices comprise CPRI physical layer devices.

The pair of optical fibers 112b that is connected to one of the plurality of RRHs 106 at one end and that normally would be connected to a corresponding BBU 104 at the other end is instead disconnected from the corresponding BBU 104 and connected to the corresponding RRH optical interface 122 of the optical PIM tester 100. One end of another pair of optical fibers 112a is connected to the corresponding BBU 104, where the other end of that second pair of optical fibers 112a is connected to the corresponding BBU optical interface 120. It is to be understood, however, that the optical PIM tester 100 can be coupled to the front-haul communication link 112 in other ways (for example, using passive optical couplers).

In the exemplary embodiment shown in FIG. 1, the optical PIM tester 100 further comprises one or more programmable processors 128 for executing software 130. The software 130 comprises program instructions that are stored (or otherwise embodied) on or in an appropriate non-transitory storage medium or media 132 (such as flash or other non-volatile memory, magnetic disc drives, and/or optical disc drives) from which at least a portion of the program instructions are read by the programmable processor 128 for execution thereby. Although the storage media 132 is shown in FIG. 1 as being included in, and local to, the optical PIM tester 100, it is to be understood that remote storage media (for example, storage media that is accessible over a network) and/or removable media can also be used. The optical PIM tester 100 also includes memory 134 for storing the program instructions (and any related data) during execution by the programmable processor 128. Memory 134 comprises, in one implementation, any suitable form of random access memory (RAM) now known or later developed, such as dynamic random access memory (DRAM). In other embodiments, other types of memory are used. Functionality described here as being implemented in software 130 can be implemented in other ways (for example, using an application specific integrated circuit (ASIC) or field programmable gate array (FPGA)).

The software 130 executing on the programmable processor 128 sends and receives frames of user plane and control plane information with the physical layer devices included in the optical interfaces 120 and 122. For example, the software 130 is configured to capture downlink frames in order to determine system information that the BBU 104 and the RRH 106 are using for communicating with each other and with the wireless units 108 over the wireless RF channel (for example, information identifying what RF frequency channels are being used to communicate over the RF frequency channel).

In this exemplary embodiment, the optical PIM tester 100 can be operated in a PIM test mode. In this mode, downlink CPRI frames are transmitted by the BBU 104 on the front-haul communication link 112a. The optical signals are received at the BBU optical interface 120, which converts the received optical signal to an electrical signal that is provided to the CPRI PHY included in the BBU optical interface 120. The CPRI PHY extracts the downlink CPRI frames from the received signals and communicates the downlink CPRI frames to the programmable processor 128 for processing by the software 130. The software 130 is configured to insert digital baseband IQ data for the PIM test signals into a desired antenna container (AxC) included in the downlink CPRI frames. That is, the baseband IQ data that the BBU 104 originally included in that AxC is replaced with the baseband IQ data for the PIM test signals. The software 130 forwards the modified downlink CPRI frames to the CPRI PHY in the RRH optical interface 122 for transmitting the modified downlink CPRI frames to the RRU 106 over the downlink fiber included in the front-haul communication link 112b. The RRU 104 extracts the digital baseband IQ data for that AxC and then generates an analog RF signal (tones) that comprises the PIM test signals and outputs the PIM test signals on the relevant antenna port 113.

Any PIM signals generated due to PIM sources (for example, at the antenna port 113, in the coaxial cable 115, at the connector connecting the coaxial cable 115 to the antenna 114 or the antenna port 113, or in the antenna 114) will show up in the uplink signals received on the antenna ports 113 of the RRH 106 and will be reflected in the uplink digital baseband IQ data transmitted by the RRH 106 in uplink CPRI frames to the associated BBU 104 via the front-haul communication link 112.

The uplink CPRI frames transmitted from the RRH 106 on the front-haul communication link 112b are captured by the optical PIM tester 100 and checked for PIM products. That is, uplink CPRI frames transmitted by the RRH 106 on the front-haul communication link 112b. The optical signals are received at the RRH optical interface 122, which converts the received optical signal to an electrical signal that is provided to the CPRI PHY included in the RRH optical interface 122. The CPRI PHY extracts the uplink CPRI frames from the received signals and communicates the uplink CPRI frames to the programmable processor 128 for processing by the software 130. The software 130 is configured to extract the uplink baseband IQ data from the AxCs included in the uplink CPRI frames and process that baseband IQ data in order to identify and characterize any PIM that may occur in the uplink in response to injecting the PIM test signals.

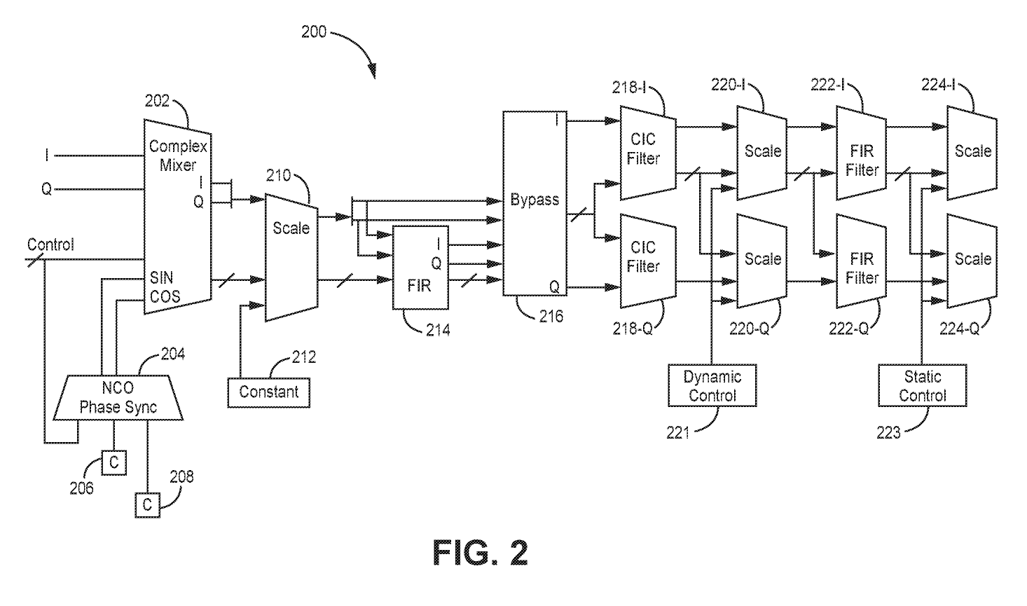

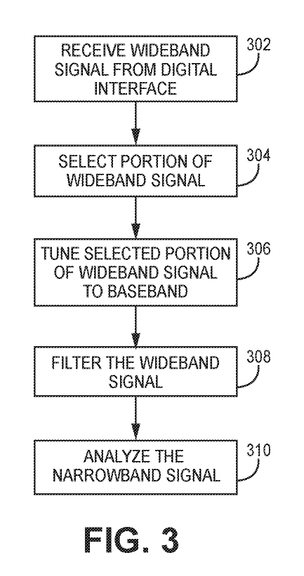

PIM tester 100 also includes digital receiver 142. Digital receiver 142 is used to tune to a frequency in the received IQ data that is associated with a potential PIM product. In one embodiment, the digital receiver 142 is constructed and operated as described below with respect to FIGS. 2 and 3.

A user can interact with the software 130 executing on the optical PIM tester 100 using a user device 136, e.g., smartphone, tablet, or computer. The user device 136 is communicatively coupled to the optical PIM tester 100. In the exemplary embodiment shown in FIG. 1, the optical PIM tester 100 includes one or more wired interfaces 138 (for example, an ETHERNET interface and/or a USB interface) and wireless interfaces 140 (for example, a Wi-Fi wireless interface) to communicatively couple the optical PIM tester 100 to a local area network or directly to the user device 136. Moreover, a remotely located user device 136 can access the optical PIM tester 100 via a connection established over the local area network and/or a public network such as the Internet. In one embodiment, the software 130 implements a webserver that is operable to present a browser-based user interface that enables a user to use a general-purpose Internet browser installed on the user device 136 to interact with the software 130 on the optical PIM tester 100.

Although optical PIM tester 100 is described primarily as implementing a technique to test signal power of a PIM signal, the techniques described herein can be used with other similar systems and devices that intercept baseband IQ data that is communicated over a front haul communication link between a BBU and RRH including, for example, optical spectrum analyzers, interference detectors and/or signal quality management systems. Moreover, one or more of these functions (for example, PIM testing, spectrum analyzer, interference detecting, and signal quality management) can be combined into a single unit.

Also, although the embodiments described above are described as using antenna carriers in downlink CPRI frames, it is to be understood that the techniques described herein can be used with other streams of baseband IQ data (for example, streams of baseband IQ data communicated over an OBSAI or ORI interface).

FIG. 2 is a block diagram of a digital receiver 200 that can be used to tune to a narrow band within a wideband signal. For example, digital receiver 200 can be used as digital receiver 142 of FIG. 1 to tune to a portion of an upstream band from a remote radio head 106 to detect a PIM product in the baseband IQ data on front-haul communication link 112. In other embodiments, digital receiver 200 can be used to detect other signals of interest within a wideband digital signal, e.g., interference, etc.

Digital receiver 200 processes IQ data that has been extracted from a digital interface. For example, the IQ data, in one embodiment comprises I and Q samples from a CPRI interface that carries signals between a baseband unit and a remote radio head such as shown in FIG. 1. Digital receiver 200 is designed to be programmed to handle IQ data with a variety of different sampling rates, and different sample widths. Further, the digital receiver is designed such that the IQ data may represent different bandwidths, e.g., 5, 10, or 20 MHz LTE signals. Further, the IQ data represents the payload data of the digital interface after the header information has been removed.

As an overview, digital receiver 200 tunes to a selected portion of the received wideband signal and then processes the selected portion as a narrowband signal to identify a characteristic of the narrowband signal, e.g., detect the presence of a PIM product in an upstream band of a cellular signal. The reason that digital receiver 200 tunes to the selected portion of the wideband signal is to reduce the noise level from the whole signal power in the wideband spectrum. Thus, by tuning to a narrow slit within the wideband signal, the digital receiver 200 reduces the burden on downstream processing components in performing additional processing, such as spectral estimation, using processes like the standard Welsh method.

In one embodiment, digital receiver 200 is implemented in a field programmable gate array (FPGA), e.g., the Arria V GZ FPGA commercially available from Altera (now part of Intel). Digital receiver 200 is implemented using signal processing blocks in the FPGA to down or up convert, down-sample, and filter the received signal from the digital interface.

Digital receiver 200 includes complex mixer 202 and numerically controlled oscillator (NCO) 204 to tune a portion of the received signal to baseband. NCO 204 is controlled by phase and sync inputs to generate oscillating signals (sin and cos) that are provided to inputs of complex mixer 202. The appropriate values are applied to the phase and sync inputs to tune to a selected portion of the wideband signal, e.g., a segment of the signal where a signal of interest is anticipated. In one embodiment, the NCO brings the selected portion of the wideband signal to within 50 KHz of the center of baseband. This could require down converting or up converting the selected portion of the wideband signal as the wideband signal is a baseband signal and the portion of interest could be located to the left of zero. Once the NCO is set, complex mixer 202 multiplies the I and Q samples by the oscillating signals and produces I and Q signals that have been moved to baseband according to the following equations: I=D*cos and Q=D*sin. Because of the multiplication involved in complex mixer 202, a scaling function 210 is provided to reduce signal growth that could lead to distortions in the output IQ data from digital receiver 200. Other scaling functions (220 and 224) are provided after other components in the receiver chain to similarly reduce signal growth and prevent distortion in the output I and Q values.

Complex mixer 202 also receives control signals. In some embodiments, these control signals enable digital receiver 200 to process multiple IQ datastreams for multiple bands, or segments of a band, in parallel. The control signals are propagated down the receiver chain as illustrated in FIG. 2.

Once the wideband signal has been tuned such that the selected area of the signal is located near the center of baseband, the signal is converted to a narrowband signal for further processing. This conversion to a narrowband signal is performed by at least one filtering process. In the embodiment shown in FIG. 2, two filtering processes may be performed in sequence. First, FIR decimation filter 214 may decimate the I and Q values from scaling function 210 by a factor of 4. It is noted that FIR decimation filter 214 is optional, and is contemplated for use with a 20 MHz wideband signal. When not used, FIR decimation filter 214 is bypassed by bypass circuit 216.

The second stage of filtering is provided by cascaded-integrator comb (CIC) decimation filter 218-I and 218-Q which decimate the respective I and Q signals from the bypass circuit 216 by 15. Filters 214 and 218 effectively down-samples the I and Q data to create narrowband signals in the selected portion of the wideband signal and is hence referred to as a “sampling rate decimator and a low pass filter.” Following the CIC decimation filters 218-I and 218-Q, digital receiver 200 has compensation filters (FIR filters 222-I and 222-Q). These compensation filters take care of the droop in the frequency spectrum of CIC decimation filter 218-I and 218-Q. The CIC decimation filters 218-I and 218-Q are very efficient in terms of implementing a very high rate of decimation. But, one problem with this type of filter is that it has a characteristic droop. To compensate for this, an appropriately designed FIR filter is provided, e.g., FIR filters 222-I and 222-Q. Inclusion of FIR filters 222-I and 222-Q make the passband gain uniform and enable measurement of the signal power in the output I and Q signals from digital receiver 200.

As mentioned above, digital receiver 200 includes a number of scaling blocks; 210, 220, and 224. The signal processing blocks in the receiver chain of digital receiver 200 display a sort of growth, rounding, or saturation on the signals going through the different stages of digital receiver 200. To reduce this impact, the outputs of the complex mixer 202, and filters 218 and 222 are fed through appropriately set scaling blocks to keep the signal growth in check.

The output of digital receiver 200 is the filtered IQ data from scaling blocks 224-I and 224-Q, respectively. These signals are narrowband in the range of 120-250 KHz depending on the incoming bandwidth. These signals are ready for analysis. In one embodiment, the I and Q signals are fed to a Welsh Spectrum estimator 144 (implemented, for example, in processor 128 of FIG. 1) to analyze and display the spectrum of this narrowband portion of the wideband signal received by receiver 200. In one embodiment, this allows an optical PIM tester to determine if a PIM product is present at a specific frequency in an uplink channel of a base station.

As mentioned above, the digital receiver 200 can be used with signals that vary in sample width and sample rates. To accommodate this, in one embodiment, digital receiver 200 dynamically adjusts the value of scaling function 220-I and 220-Q. The scaling value for scaling function 220-I and 220-Q is set by dynamic control register 221. This value is set based on the root-mean-square power of the incoming IQ signal to receiver 200. Using this dynamic control, the IQ signals output from receiver 200 do not truncate, or have other distortions introduced. This in turn reduces the likelihood of false detection of signals of interest in the baseband. In one embodiment, the dynamic scaling value is calculated as follows:

The signal level is calculated over 1 ms observation of the captured data. Hence, the number of samples collected would vary with the sampling rate or the bandwidth. For 1× rate, the number of samples would be 3840 and for higher sampling rates it would be multiplied by the ratio to the 1× rate. The number of bits occupied will be calculated from the I/Q samples according to the following equation (1), where N is total number of complex samples.

$$Number of Bits L = ceil ( {0.5}^{⋆} ( \frac{log \{ {\sum }_{K = 0}^{N - 1} ( {I}_{k}^{2} + {Q}_{k}^{3} ) \}}{log 2} - \frac{log N}{log 2} - 1 ) + \frac{log 3}{log 2} ) \qquad ( 1 )$$

where, O<L<16

The number of bits, L will be used to write the register value in the Dynamic Control Register 221 according to the mapping below where V_{R} is the Dynamic Control Register Value:

V_{R}=L−9 for L>=9, and

V_{R}=0 for L<9 (2)

The actual scaling value is defined as, Sₐ=2^{-9-V}^{_{R}}

It is noted that this calculation of the dynamic scaling value is provided by way of example and not by way of limitation. In other embodiments, different scaling values can be used based on the specific design of the digital receiver chain.

The advantage of downsampling (reducing the sampling rate) and bringing the signal to baseband is how easily the spectral estimation can be done. For example, doing a spectral estimation on a 10 MHz signal (wideband) is computationally intensive. Also, stabilization of the noise and stabilization of the parameters to measure the signal quality gets really difficult. So this process does two things: (1) it reduces the noise and (2) it allows a better spectral estimation by using a narrowband.

It is not just spectral estimation that can be done with the narrowband output of digital receiver 200. Any sort of analysis can be done in time or frequency domain to analyze the content of the signal. Using the digital receiver 200, a wideband signal, e.g., a 10 MHz signal, may be broken down into smaller segments of narrow band signals and analyzed in segments. This provides an efficient way to look at a wideband signal by dividing the wideband signal up into narrow bands and looking at each separately.

FIG. 3 is a flow chart that illustrates a process for analyzing a wideband signal from a digital interface such as a wideband signal from a remote radio head to a baseband unit. The method begins at block 302 where a wideband signal is received from a digital interface such as a IQ data from a CPRI, OBSAI or ORI interface. At block 304, the method proceeds to select a portion of the wideband signal for further analysis. For example, in one embodiment, the selected portion of the wideband signal comprises a portion of the wideband signal that could include a passive intermodulation (PIM) product. At block 306, the method tunes the selected portion of the wideband signal to baseband. For example, with CPRI, the received wideband signal is located at baseband. However, to simplify the analysis of a portion of the wideband signal, that portion of the wideband signal is moved to be close to baseband, e.g., within 50 KHz of the center of zero frequency. Then, the wideband signal is filtered using an appropriate filter to down-sample the wideband signal at block 308. This effectively turns the wideband signal into a narrowband signal and reduces the processing burden in analyzing the spectrum of the selected segment of the wideband signal. As discussed above, this down-sampling is accomplished in one embodiment with a combination of FIR and CIC decimating filters. Finally, at block 310, the narrowband signal is analyzed. For example, the narrowband signal is fed into a Welsh function to analyze the spectrum of the narrowband signal to determine if a signal of interest is present in the narrowband signal, e.g., a signal to noise floor power ratio within the narrowband signal is monitored. Advantageously, averaging the magnitude of the fast Fourier transform (FFT) outputs of selected narrowband portions of spectrum (e.g., the Welsh function) in the presence of Gaussian noise improves the detection of narrowband signals in wideband receivers.

### Process for Passive Intermodulation Testing

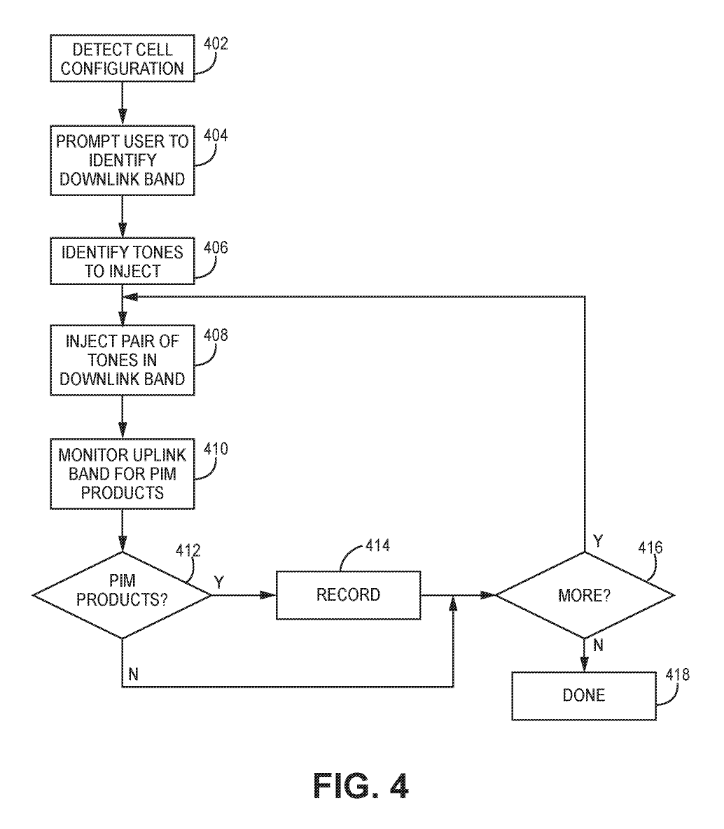

FIG. 4 is a flow diagram of one exemplary embodiment of a method of testing for PIM products in a distributed base station, such as system 102 of FIG. 1. The process may be used to test for PIM products on a single cell or band. Alternatively, the process can also be applied, in other embodiments, for cross-band PIM testing in which test signals from one or more bands combine to produce PIM products in any of the uplink bands of the distributed base station, such as system 102 of FIG. 1. Advantageously, the process of FIG. 4 can perform cross-band PIM testing using the system of FIG. 1 without the need for complex synchronization techniques because the PIM tester 100 generates all test signals in a unified platform for all bands.

The process of PIM testing begins by gathering information to establish the parameters of the PIM testing. First, at block 402, the process detects the cell configuration for the distributed base station to determine the types of cells to be tested, e.g., LTE, WCDMA, etc. To do this, a technician connects the optical PIM tester 100 into the front-haul communication link 112 between at least one BBU 104 and a corresponding RRH 106. Processor 128 executes program instructions from software 130 to detect the CPRI parameter configuration and extract the cell ID from the baseband IQ data transported over the front-haul communication link 112 for each cell to be tested, e.g., as described in U.S. Pat. No. 9,014,052. The process next prompts the user to identify the downlink band that is used for each detected cell at block 404. In one embodiment, processor 128 executes program code to present a list of possible downlink bands to the user at user device 136 through either the wired or wireless interfaces 138 and 140, respectively. Alternatively, the downlink bands may also be detected by PIM tester 100.

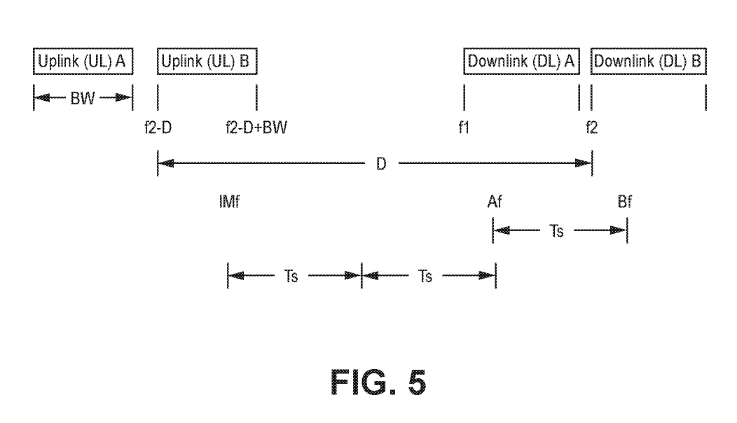

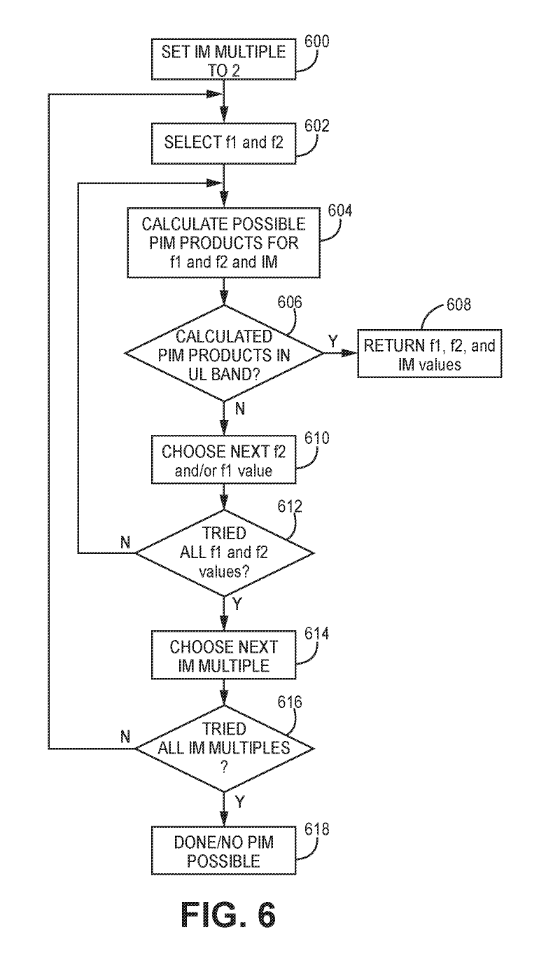

Once the downlink bands to be tested are known, the process proceeds to identify one or more tones to be injected in the downlink bands to test for PIM products at block 406. Example processes for selecting the test tones are described below with respect to FIGS. 5 and 6. In general, the process pairs each frequency or tone in the downlink band with each other frequency or tone in the downlink band. The process then calculates the potential PIM products (e.g., 2^{nd} order, 3^{rd} order, 4^{th} order, 5^{th} order, 7^{th} order, 9^{th} order, etc.) for each pair of tones and determines which, if any, of these potential PIM products fall within an uplink band of the system.

In one embodiment, the process tests for PIM products in the distributed base station by injecting the identified tone pairs in the downlink band, at block 408, and then monitoring the uplink band for the potential PIM products at block 410. In one embodiment, the process tunes a narrowband receiver to a frequency of the potential PIM product as described above, for example, with respect to FIGS. 2 and 3. Then the process applies a Fast Fourier Transform (FFT) to the data from the narrowband receiver. At block 412, the process determines whether there are PIM products at the expected frequency. For example, the process compares the magnitude of the signal from the FFT against a specified threshold. If the signal exceeds the threshold, the process records the existence of a PIM product in that band at block 414. In another embodiment, the process averages the value of the signal over a period of time or runs the test multiple times before declaring the presence of a PIM product to make the process less likely to falsely identify user traffic as a PIM product. PIM products typically are more persistent while user traffic is generally more dynamic. Thus, testing for PIM products over a time window (including running the same test tones multiple times) can reduce the likelihood of a false positive PIM indication due to the presence of non-PIM signals at or near the same frequency.

In another embodiment, the tones injected at block 408 are modulated with a selected modulation scheme. For example, the tones may be modulated with a simple on-off pattern. If PIM products result from the injected tones, the PIM products will also exhibit the same modulation. Thus, at block 410, when monitoring for PIM products, the process looks for signals at the designated uplink frequencies that exhibit the same modulation, e.g., an on-off pattern. Alternatively, in other embodiments, a higher order modulation scheme, such as phase or frequency modulation, is used. With the use of such modulation, it may be possible to detect PIM products with lower signal-to-noise ratio due to some gain in the demodulation of the PIM products.

In other embodiments, it is desirable to conduct cross-band testing to detect PIM products in systems in which only one of the bands of the system uses a front-haul communication link that that can be tapped into by the optical PIM tester 100, e.g., the system uses a CPRI interface between the BBU 104 and the RRH 106. For example, the system has an LTE band with, for example, a CPRI interface and a CDMA band that does not have a CPRI interface. In this instance, the process injects a tone in the baseband IQ data of the downlink LTE channel at block 408. This injected tone is advantageously modulated, e.g., with on-off, phase or frequency modulation. Alternatively, the process injects a signal with a known cyclostationary signature (a signal that has a statistical property that varies cyclically with time). At block 410, the process monitors the uplink band to detect for PIM products. To do this, the process monitors the uplink band to determine if the noise floor exhibits the same modulation as the injected tone. For example, if the tone is injected with on-off modulation, then PIM products are detected if the noise in the uplink band also exhibits this characteristic.

At block 416, the process determines whether additional pairs of test tones need to be applied to the downlink bands. If not the process ends at block 418. If additional pairs of tones are available to test, the process returns to block 408 and injects the tones in the appropriate downlink bands.

### Identifying Potential PIM Products

FIG. 5 is a spectrum diagram that illustrates an example of calculations that can be used to identify the location of potential PIM products in a distributed base station having two downlink channels according to one embodiment of the present invention. In this example, a base station optical link has been configured with two pairs of downlink (DL A and DL B) and uplink (UL A and UL B) channels. Downlink channel DL A is located at starting frequency f1 and downlink channel DL B is located at starting frequency f2. Each channel (UL and DL) in this example has a bandwidth (BW) of, for example, 5, 10, 15, or 20 MHz. Further, the duplex spacing for the downlink and uplink channels is labelled D in FIG. 5. Although the uplink channel is shown at a lower frequency than the upstream channel, it is noted that the opposite configuration could also be used with the uplink channel at a higher frequency than the downlink channel.

The objective of this analysis is to identify pairs of frequencies in the downlink band(s) that have the potential to produce the lowest order PIM products in one or more of the uplink bands when, for example, tones or modulated signals are injected at one or more of the identified frequency pairs. In FIG. 5, example frequencies are labeled Af and Bf in the two downlink channels and they have the potential to produce the lowest order PIM product (and correspondingly, potentially the highest power PIM product) in the B uplink channel. As indicated, Af and Bf are separated by a tone separation of Ts where: Ts=Bf−Af. IMf, the potential PIM product frequency, will always be some multiple (M) of Ts below Af (or above Bf when the uplink channels are at a higher frequency than the downlink channels). As illustrated, IMf is two multiples of Ts below Af. The value of the frequency, IMf, is given by IMf=Af−M*Ts where in this case M is 2. The IM order for this potential PIM product is 2*M+1. In the example, IM is 5.

It is noted that this application is not limited to this formula for calculating PIM products, nor is the application limited to these orders of potential PIM products. For example, other possible formulas include 2f2 or f2−f1 (both second order PIM products) and 3f2−f1 or 2f2−2f1, both for fourth order PIM products and 4f2-f1 for fifth order PIM products, by way of illustration and not by way of limitation. Any appropriate formula for calculating PIM products can also be used and the teachings of the present invention is not limited to any particular technique or formula for calculating PIM products.

There may be multiple PIM products calculated for a given set of BW, D, f1 and f2. The process selects the lowest order IM possible with values of Af, Bf and IMf. Further, the process also favors selecting frequencies Af and Bf that are away from the edges of the downlink channel to eliminate the effects of the filters of the channel on the selection of frequencies to be used for PIM testing.

One method to find the appropriate values for Af and Bf is to step through the possible values (using a reasonable step value like 0.1 MHz) starting with the lowest IM value (2^{nd} order) and calculate IMf. Then, the process validates that the calculated value of IMf falls within the appropriate section of the UL channel (not near the edges and not near the center) and stops when an appropriate test frequency has been identified. If an appropriate test frequency was not identified at the current IM multiple, the IM multiple is increased to the next (3^{rd} order) and the test of the Af and Bf frequencies is repeated. The process is further repeated for IM orders such as 4^{th}, 5^{th}, 7^{th}, 11^{th}, 13^{th} and 15^{th} orders, if necessary.

It is noted that the description of FIG. 5 relates to cross-band PIM testing in that the tones or frequencies used to calculate the potential PIM products originate in different downlink bands. The same process described above can be used when selecting two tones or frequencies in the same downlink band. Further, in this embodiment, the process looks for PIM products in uplink band(s) that are directly related to (paired with) the downlink bands. In other embodiments, the process may look for PIM products in one or more uplink bands not directly associated with the downlink band(s).

FIG. 6 is a flow diagram of another exemplary embodiment of a method for identifying pairs of tones to be used for PIM testing in a distributed base station. As mentioned above with respect to FIG. 5, one process to find appropriate test tones for locating potential PIM products is to step through the possible combinations of frequencies in the downlink channel or channels. By stepping through the possible combinations, a list of pairs of test tones is produced that is a subset of the possible pairs of tones in the downlink bands. FIG. 6 is a flow diagram that illustrates such an embodiment.

The process of FIG. 6 begins at block 600 by setting the IM multiple to 2. At block 602, the process selects an initial pair of frequencies or tones (e.g., carrier wave or modulated signal). In one embodiment, the selected tones are selected in the same downlink band. In other embodiments, the tones are selected from different downlink bands to check for cross-band PIM products. In one embodiment, the tones are selected based on a step value of, for example, 0.1 MHz, although other step values can be chosen for a given implementation.

With the first pair of tones selected, the process moves on to considering potential PIM products associated with the pair of tones. At block 604, the process calculates the potential PIM product(s) for the current IM multiple. At block 606, the process determines if any of the PIM product(s) fall within an uplink band for the distributed base station under test. If so, the process returns the pair of tones at block 608 and notes the order (IM value) of the potential PIM product.

If none of the PIM product(s) fall within the uplink band, the possible values for the pair of frequencies are iterated through at blocks 610 and 612 until all values of f1 and f2 have been tried for the current order of PIM products and their corresponding PIM product(s) are tested against the uplink band. The IM multiple value is increased at block 614 and the process repeats until, at block 616, the process determines that all IM multiples are tried or until a valid PIM product is found at block 606. The process ends at block 618.

### Example Embodiments

Example 1 includes a digital receiver, comprising: an oscillator that generates an oscillating signal at a selected frequency; a complex mixer, coupled to the oscillator and configured to receive samples of a wideband signal from a digital interface, wherein the complex mixer moves a signal of interest in the wideband signal to baseband; at least one filter, coupled to the complex mixer, that down-samples the baseband signal to a narrowband signal; and an output, coupled to the at least one filter, that is adapted to output the narrowband signal for analysis.

Example 2 includes the digital receiver of Example 1, wherein the at least one filter comprises a cascaded-integrator comb (CIC) filter.

Example 3 includes the digital receiver of Example 2, wherein the at least one filter further comprises a compensation filter coupled to the output of the CIC filter to compensate for the droop in the CIC filter.

Example 4 includes the digital receiver of Example 3, wherein the at least one filter further comprises a finite impulse response (FIR) filter, coupled between the complex mixer and the CIC filter, the FIR filter configured to decimate the output of the complex mixer by a factor of 4 when the FIR filter is not bypassed.

Example 5 includes the digital receiver of any of Examples 1-4, wherein the complex mixer is configured to receive baseband I and Q data from an front-haul communication link between a remote radio head (RRH) and a baseband unit (BBU) in a distributed base transceiver station.

Example 6 includes the digital receiver of any of Examples 1-5, wherein the oscillator comprises a numerically controlled oscillator (NCO), the NCO configured to receive a signal associated with a frequency of a potential passive intermodulation (PIM) product in the wideband signal.

Example 7 includes the digital receiver of any of Examples 1-6, and further including at least one scaling block coupled between the at least one filter and the output.

Example 8 includes the digital receiver of Example 7, wherein the at least one scaling block dynamically scales the signal provided to the output based on the incoming wideband signal.

Example 9 includes the digital receiver of any of Examples 1-8, wherein the output is coupled to a Welsh Spectrum estimator to analyze the narrowband signal.

Example 10 includes a method for detecting a signal of interest in a wideband signal from a digital interface, the method comprising: receiving the wideband signal at the digital interface; selecting a portion of the wideband signal that could contain the signal of interest; tuning the selected portion of the wideband signal to baseband; filtering the wideband signal to create a narrowband signal at the selected portion of the wideband signal; and analyzing the narrowband signal to detect whether the signal of interest is present.

Example 11 includes the method of Example 10, wherein detecting whether the signal of interest is present comprises detecting the presence of a Passive Intermodulation (PIM) signal.

Example 12 includes the method of any of Examples 10-11, wherein selecting a portion of the wideband signal comprises selecting a portion of the wideband signal based on the anticipated PIM product of a two tone PIM test.

Example 13 includes the method of any of Examples 10-12, wherein selecting a portion of the wideband signal comprises selecting one of a number of portions of the wideband signal based on an nth order PIM product.

Example 14 includes the method of any of Examples 10-13, wherein filtering the wideband signal to create a narrowband signal comprises filtering the wideband signal with a sampling rate decimator and a low pass filter.

Example 15 includes the method of any of Examples 10-14, wherein detecting whether the signal of interest is present comprises monitoring a signal to noise floor power ratio within the narrowband signal.

Example 16 includes the method of any of Examples 10-15, and wherein analyzing the narrowband signal comprises performing spectral analysis on the narrowband signal.

Example 17 includes a passive intermodulation tester, comprising: at least one interface to communicatively couple the tester unit to a front-haul communication link used for communicating front-haul data to a remote radio head (RRH) having one or more antenna ports; a programmable processor, coupled to the interface, configured to execute software, wherein the software is operable to cause the tester to do the following: identify at least one tone in at least one downlink band of the remote radio head, wherein potential PIM products may appear in at least one uplink band of the remote radio head in response to the identified at least one tone; inject the identified at least one tone in the at least one downlink band of the remote radio head; a digital receiver that receives a wideband signal on the at least one uplink band and tunes to a selected, narrowband, portion of the wideband signal that is associated with the potential PIM product; and record the existence of the potential PIM products when detected.

Example 18 includes the passive intermodulation detector of Example 17, wherein the digital receiver comprises: an oscillator that generates an oscillating signal at a selected frequency; a complex mixer, coupled to the oscillator and configured to receive samples of the wideband signal on the at least one uplink band, wherein the complex mixer moves a signal of interest in the wideband signal to baseband; at least one filter, coupled to the complex mixer, that down-samples the baseband signal to a narrowband signal; and an output, coupled to the at least one filter, that is adapted to output the narrowband signal for analysis.

Example 19 includes the passive intermodulation detector of Example 18, wherein the at least one filter further comprises a compensation filter coupled to the output of the CIC filter to compensate for the droop in the CIC filter.

Example 20 includes the passive intermodulation detector of Example 19, wherein the at least one filter further comprises a finite impulse response (FIR) filter, coupled between the complex mixer and the CIC filter, the FIR filter configured to decimate the output of the complex mixer by a factor of 4 when the FIR filter is not bypassed.

Example 21 includes the passive intermodulation detector of any of Examples 17-20, wherein the complex mixer is configured to receive baseband I and Q data from the front-haul communication link between the remote radio head (RRH) and a baseband unit (BBU) in a distributed base transceiver station.

Example 22 includes the passive intermodulation detector of any of Examples 17-21, wherein the oscillator comprises a numerically controlled oscillator (NCO), the NCO configured to receive a signal associated with a frequency of a potential passive intermodulation (PIM) product in the wideband signal.

Example 23 includes the passive intermodulation detector of any of Examples 17-22, and further including at least one scaling block coupled between the at least one filter and the output.

Example 24 includes the passive intermodulation detector of Example 23, wherein the at least one scaling block dynamically scales the signal provided to the output based on the incoming wideband signal.

Example 25 includes the passive intermodulation detector of any of Examples 17-24, wherein the output is coupled to a Welsh Spectrum analyzer to analyze the narrowband signal.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A digital receiver, comprising:
an oscillator that generates an oscillating signal at a selected frequency;
a complex mixer, coupled to the oscillator and configured to receive samples of a wideband signal from a digital interface, wherein the complex mixer moves a signal of interest in the wideband signal to baseband;
at least one filter, coupled to the complex mixer, that down-samples the baseband signal to a narrowband signal;
an output, coupled to the at least one filter, that is adapted to output the narrowband signal for analysis; and
at least one scaling block coupled between the at least one filter and the output. wherein the at least one scaling block dynamically scales the narrowband signal provided to the output based on the incoming wideband signal.

2. The digital receiver of claim 1, wherein the at least one filter comprises a cascaded-integrator comb (CIC) filter.

3. The digital receiver of claim 2, wherein the at least one filter further comprises a compensation filter coupled to an output of the CIC filter to compensate for a droop in the CIC filter.

4. The digital receiver of claim 3, wherein the at least one filter further comprises a finite impulse response (FIR) filter, coupled between the complex mixer and the CIC filter, the FIR filter configured to decimate the output of the complex mixer by a factor of 4 when the FIR filter is not bypassed.

5. The digital receiver of claim 1, wherein the complex mixer is configured to receive baseband I and Q data from an front-haul communication link between a remote radio head (RRH) and a baseband unit (BBU) in a distributed base transceiver station.

6. The digital receiver of claim 1, wherein the oscillator comprises a numerically controlled oscillator (NCO), the NCO configured to receive a signal associated with a frequency of a potential passive intermodulation (PIM) product in the wideband signal.

7. (canceled)

8. (canceled)

9. The digital receiver of claim 1, wherein the output is coupled to a Welsh Spectrum estimator to analyze the narrowband signal.

10. A method for detecting a signal of interest in a wideband signal from a digital interface, the method comprising:
receiving the wideband signal at the digital interface;
selecting a portion of the wideband signal that could contain the signal of interest;
tuning the selected portion of the wideband signal to baseband;
filtering the wideband signal to create a narrowband signal at the selected portion of the wideband signal; and
analyzing the narrowband signal to detect whether the signal of interest is present.

11. The method of claim 10, wherein detecting whether the signal of interest is present comprises detecting the presence of a Passive Intermodulation (PIM) signal.

12. The method of claim 10, wherein selecting a portion of the wideband signal comprises selecting a portion of the wideband signal based on the anticipated PIM product of a two tone PIM test.

13. The method of claim 10, wherein selecting a portion of the wideband signal comprises selecting one of a number of portions of the wideband signal based on an nth order PIM product.

14. The method of claim 10, wherein filtering the wideband signal to create a narrowband signal comprises filtering the wideband signal with a sampling rate decimator and a low pass filter.

15. The method of claim 10, wherein detecting whether the signal of interest is present comprises monitoring a signal to noise floor power ratio within the narrowband signal.

16. The method of claim 10, and wherein analyzing the narrowband signal comprises performing spectral analysis on the narrowband signal.

17. A passive intermodulation tester, comprising:
at least one interface to communicatively couple the tester unit to a front-haul communication link used for communicating front-haul data to a remote radio head (RRH) having one or more antenna ports;
a programmable processor, coupled to the interface, configured to execute software, wherein the software is operable to cause the tester to do the following:
identify at least one tone in at least one downlink band of the remote radio head, wherein potential PIM products may appear in at least one uplink band of the remote radio head in response to the identified at least one tone;
inject the identified at least one tone in the at least one downlink band of the remote radio head;
a digital receiver that receives a wideband signal on the at least one uplink band and tunes to a selected, narrowband, portion of the wideband signal that is associated with the potential PIM product; and
wherein the software is further operable to record the existence of the potential PIM products when detected in an output of the digital receiver.

18. The passive intermodulation detector of claim 17, wherein the digital receiver comprises:
an oscillator that generates an oscillating signal at a selected frequency;
a complex mixer, coupled to the oscillator and configured to receive samples of the wideband signal on the at least one uplink band, wherein the complex mixer moves a signal of interest in the wideband signal to baseb and;
at least one filter, coupled to the complex mixer, that down-samples the baseband signal to a narrowband signal; and
an output, coupled to the at least one filter, that is adapted to output the narrowband signal for analysis.

19. The passive intermodulation detector of claim 26, wherein the at least one filter further comprises a compensation filter coupled to the output of the CIC filter to compensate for the droop in the CIC filter.

20. The passive intermodulation detector of claim 19, wherein the at least one filter further comprises a finite impulse response (FIR) filter, coupled between the complex mixer and the CIC filter, the FIR filter configured to decimate the output of the complex mixer by a factor of 4 when the FIR filter is not bypassed.

21. The passive intermodulation detector of claim 18, wherein the complex mixer is configured to receive baseband I and Q data from the front-haul communication link between the remote radio head (RRH) and a baseband unit (BBU) in a distributed base transceiver station.

22. The passive intermodulation detector of claim 18, wherein the oscillator comprises a numerically controlled oscillator (NCO), the NCO configured to receive a signal associated with a frequency of a potential passive intermodulation (PIM) product in the wideband signal.

23. The passive intermodulation detector of claim 18, and further including at least one scaling block coupled between the at least one filter and the output.

24. The passive intermodulation detector of claim 23, wherein the at least one scaling block dynamically scales the signal provided to the output based on the incoming wideband signal.

25. The passive intermodulation detector of claim 18, wherein the output is coupled to a Welsh Spectrum analyzer to analyze the narrowband signal.

26. The passive intermodulation detector of claim 18, wherein the at least one filter comprises a cascaded-integrator comb (CIC) filter.
